(19) United States
(12) Patent Application Publication
(10) Pub. No.: US 2018/0324901 A1
(43) Pub. Date: Nov. 8, 2018

(54) ELECTRIC HEATER WITH COIL BODY

(71) Applicant: TÜRK & HILLINGER GMBH, Tuttlingen (DE)

(72) Inventor: Andreas SCHLIPF, Tuttlingen (DE)

(21) Appl. No.: 15/971,336

(22) Filed: May 4, 2018

(30) Foreign Application Priority Data
May 5, 2017 (DE) 20 2017 102 706.6

(51) Int. Cl. H05B 3/44; H05B 3/06; H05B 3/18; H05B 3/46

(52) U.S. Cl. CPC H05B 3/44; H05B 3/06; H05B 2203/037; H05B 3/46; H05B 2203/002; H05B 3/18

(57) ABSTRACT

An electric heater (100, 200, 300, 400, 600, 700, 800, 900) has at least one coil body (110, 210, 310, 410, 510, 610, 660, 670, 710, 810, 860, 910, 1010) in the form of a tube having any desired cross section, in the form of a partially slotted tube having any desired cross section or in the form of a slotted tube having any desired cross section and at least one electric heating element (120, 220, 320, 420, 520, 620, 621, 622, 720, 820, 870, 920, 1020), which is wound onto the coil body. The electric heating element is wound onto the coil body to both extend over sections of the inner side (515, 915) of the tube, partially slotted tube or slotted tube forming the coil body and sections of the outer side (516, 916) of the tube, partially slotted tube or slotted tube forming the coil body.

### CROSS REFERENCE TO RELATED APPLICATIONS

This application claims the benefit of priority under 35 U.S.C. § 119 of German Application 20 2017 102 706.6, filed May 5, 2017, the entire contents of which are incorporated herein by reference.

### FIELD OF THE INVENTION

The present invention pertains to an electric heater with a coil body, onto which an electric heating element, typically a resistance wire, is wound.

### BACKGROUND OF THE INVENTION

The electric heating element has hitherto been wound or coiled, as a rule, on the outer circumference of a coil body with a usually circular cross section. This causes the ends of the electric heating element to be inevitably arranged at mutually opposite ends of the coil body. If this is not desirable, it is only possible to return the electric heating element, especially through a hole. It is always problematic to accomplish this without the winding springing up and (contrary to the winding process itself), it can hardly be accomplished in an automated manner. In addition, there are applications in which it would be desirable to accommodate a greater length than can be achieved with this type of winding in order to reduce the load of the electric heating element.

### SUMMARY OF THE INVENTION

An object of the present invention is therefore to provide an improved electric heater with coil body, which heater reduces this problem.

The electric heater according to the present invention has at least one coil body in the form of a tube having any desired cross section, in the form of a partially slotted tube having any desired cross section or in the form of a slotted tube having any desired cross section and it has at least one electric heating element, which is wound onto the coil body. In other words, the heating element is consequently wound around the coil body and is usually in contact with this in at least some sections.

A slotted tube is present especially if a recess passes through the tube jacket from one end face thereof to the other end face thereof, and a partially slotted tube is present if the recess passes through only one section of the tube jacket between the end faces thereof.

It is essential for the present invention that the electric heating element is wound onto the coil body such that it extends over both sections of the inner side of the tube or slotted tube forming the coil body and sections of the outer side of the tube or slotted tube forming the coil body.

It is achieved through this measure that both the inner surface of the coil body and the outer surface of the coil body can be used to arrange sections of the electric heating element typically configured as a heating or resistance wire thereon, which leads not only to a considerable increase in the length of the electric heating element that can be arranged on the coil body and can reduce the load thereon at a given heat output because of the possibility of using the outer and inner coil body surfaces.

If the electric heating element is wound onto the coil body such that it alternatingly extends over sections of the inner side of the tube or slotted tube forming the coil body and over sections of the outer side of the tube, slotted tube or partially slotted tube forming the coil body, this leads to advantages in terms of the manufacturing technology, because, especially if the electric heating element extends between a section that extends on the inner side of the tube, partially slotted tube or slotted tube forming the coil body and a section that extends on the outer side of the tube, partially slotted tube or slotted tube forming the coil body, over an end face of the tube, partially slotted tube or slotted tube forming the coil body, such an arrangement can be obtained in one winding process, which takes, however, place in the axial direction, instead of, as before, essentially in the circumferential direction of the coil body. This is a winding process in which it is possible to obtain ends of the electric heating element pointing towards the same end face of the coil body by the winding process.

It is also not absolutely necessary with this type of winding operation for the coil body to be porous, because a press contacting can be eliminated and the ends of the electric heating element that are oriented in the same direction can be contacted simply directly, e.g., by crimp contacts.

It becomes possible, especially for short coil bodies, to use extremely cost-effective ceramic pressed parts, which was not usually possible in the case of the conventional winding technique.

A special advantage of the configuration of the coil body as a slotted tube becomes apparent in this variant of the present invention. To obtain the just-described configuration of the electric heating element, the electric heating element must be passed through the coil body once in the axial direction for each turn in the case of a closed tube. By contrast, this can be replaced in the configuration as a slotted tube by the section of the electric heating element that is to be arranged on the inner side of the coil body being able to be inserted through the slot in an essentially radial direction, which greatly expedites the winding process and further reduces the effort needed for automating it.

The terminology used in the application to describe the geometry of tubular slotted, partially slotted or unslotted coil bodies and the arrangement of the electric heating element shall once again be explained here explicitly as a precaution, even though this is actually understandable for the person skilled in the art. This terminology derives from a generalization description of a tube having a cylindrical geometry, in which tube the extension direction is predefined by the cylinder axis and the points belonging to the tube jacket can be defined by a distance range in the radial direction, i.e., at right angles to the cylinder axis, and by a polar angle. Correspondingly, there is a polar angle range of a few degrees, in which there is no tube jacket in the radial direction.

The end faces of the tubular coil body are thus circular rings in the cylinder geometry and ring sectors in the clotted cylinder geometry.

Even if such a cylinder geometry or slotted cylinder geometry is in many cases preferred for electric heaters, it is not obligatory. Thus, the distance range in which the tube jacket forming the coil body is arranged in the radial direction may vary as a function of the polar angle, as a result of which any desired constant tube cross section, i.e., any desired constant cross-sectional circumference, can thus be described with the same terminology. If the distance range is additionally allowed to vary as a function of the position on the tube axis, tube geometries with changes in cross section can thus be described, and the degree of freedom still missing for the description of tubes having a curved course can be obtained by varying the direction of the tube axis (which defines the position of the polar plane formed in the space by the local radius vectors) as a function of the distance to one of the tube openings in a parametrized manner. Consequently, simply cylindrical coordinates or the terminology of a cylinder geometry, whose orientation in space is, however, position-dependent, are used for the description.

The extension direction of the tube or the direction in which the tube extends, which is defined by the cylinder axis in case of the cylindrical tube, is then defined in the same manner locally by the direction in which the axis extends at the defined position of the tube; the course of the tube is predefined by a corresponding three-dimensional curve.

It is especially preferred if there is a section of the electric heating element that extends parallel offset in the radial direction on the outer side of the tube, partially slotted tube or slotted tube forming the coil body for sections of the electric heating element that extend on the inner side of the tube, partially slotted tube or slotted tube forming the coil body, and/or if the section extending over an end face of the tube, partially slotted tube or slotted tube forming the coil body extends in a direction deviating from the radial direction. This can be embodied in an especially simple and reproducible manner in terms of the winding technique.

An especially cost-effective, but extremely high-output electric heater is obtained if the electric heating element is fixed and insulated in at least some sections by embedding in an electrically insulating. This may be especially an enameling, a lacquer layer or a ceramic compound.

As an alternative or in addition, the coil body thus wound may, however, also be received in a proven manner in a tubular metal jacket, as is common, for example, in case of heating cartridges. The electrical insulation against the tubular metal jacket may preferably be guaranteed by an electrically insulating material, e.g., granular MgO, in the alternative embodiment.

It may be advantageous for various applications if the distance between adjacent sections of the electric heating element, which are led over sections of the inner side of the tube, partially slotted tube or slotted tube forming the coil body or which are led over sections of the outer side of the tube, partially slotted tube or slotted tube forming the coil body, varies in the circumferential direction of the tube, partially slotted tube or slotted tube forming the coil body from section to section (i.e., between different adjacent pairs of sections), or, in other words, it depends on the polar angle. On the one hand, the release of heat, which is reduced in the area of the slot in the coil body, can be compensated by this measure despite the use of a slotted coil body if the winding density is increased in the sections of the coil body located adjacent to the slot.

On the other hand, it is also possible, however, to provide an electric heater whose heat output can not only be varied in a specific manner in the extension direction thereof, but it also deviates from an isotropic emission characteristic in respect to the polar angle.

If at least one hole, which preferably connects the two end faces of the jacket to one another, is arranged in the jacket of the tube, partially slotted tube or slotted tube forming the coil body, this hole can be used to insert terminal wires, with which the electric heating element can be supplied with power. As a result, it will then also be especially simple to supply a plurality of such coil bodies of such an electric heater with power by simply using a common connection wire, on which the coil bodies are strung up with the holes and with which the electric heating elements of all coil bodies will thus be in electrical contact, so that the power supply is guaranteed.

It becomes possible to use the electric heater in an especially flexible manner by the electric heater having more than one coil body, in which case a plate or disk, which may especially also be ring-shaped and which consists of an electrically insulating material, is preferably arranged between adjacent coil bodies. It is also possible in this manner, e.g., to combine coil bodies having different winding configurations with one another in the same electric heater or to create unheated areas of the electric heater. The plates or disks may also be used at the same time as positioning disks.

It is especially preferred if the electric heater has at least two different areas heated at different intensities. These may be arranged on different coil bodies, which may differ in terms of the winding pattern, but also in terms of the electric heating element used, i.e., they may have different resistance wires.

As an alternative or in addition, different areas heated at different intensities may be located adjacent to one another in the circumferential direction, i.e., different polar angle ranges may be heated at different intensities. The spatial distribution of the heat output can correspondingly be influenced in a specific manner.

If the perimeter of the cross section of the coil body at right angles to the extension direction thereof has at least one straight section, the differences between the inner circumference and the outer circumference of the coil body configured as a tube, partially slotted tube or as a slotted tube can be prevented from becoming noticeable in this section. This is achieved, in particular, if the perimeter of the cross section of the coil body is a polygon.

The coil body is arranged between an outer tubular metal jacket and an inner tubular metal jacket in a preferred embodiment of the electric heater.

If the coil body is formed by a partially slotted tube or a slotted tube, a sensor element and/or feed lines may be arranged in the slot especially well and in any desired axial position. This is, of course, also possible in a separate hole or recess of the coil body.

It is especially preferred if the coil body has spacers on its outer side or inner side. These may be used as positioning aids for arranging the wound coil body in the tubular metal jacket of an electric heater in as reliable process, but they also support the filling of the remaining interior space of the electric heater with an electrically insulating material having good thermal conductivity, such as MgO powder or granular MgO, because they provide a defined gap, through which the material can trickle.

If the coil body has guides on its end face for sections of the electric heating element, the position of the windings of the electric heating element can easily be fixed. This is also true if the coil body has recesses or grooves, into which the sections of the electric heating element are inserted. It is preferred in this connection that the grooves or recesses of the coil body have an undercut. It is especially preferred if the sections of the electric heating element inserted into the grooves or recesses are plastically deformed.

The present invention will be explained in more detail below on the basis of figures, which represent exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a perspective view of a first electric heater;

FIG. 1b is a cross sectional view through the electric heater from FIG. 1a along the longitudinal axis thereof;

FIG. 1c is a perspective view of the wound coil body of the electric heater from FIG. 1a;

FIG. 2a is a perspective view showing a variant of the electric heater from

FIG. 1a;

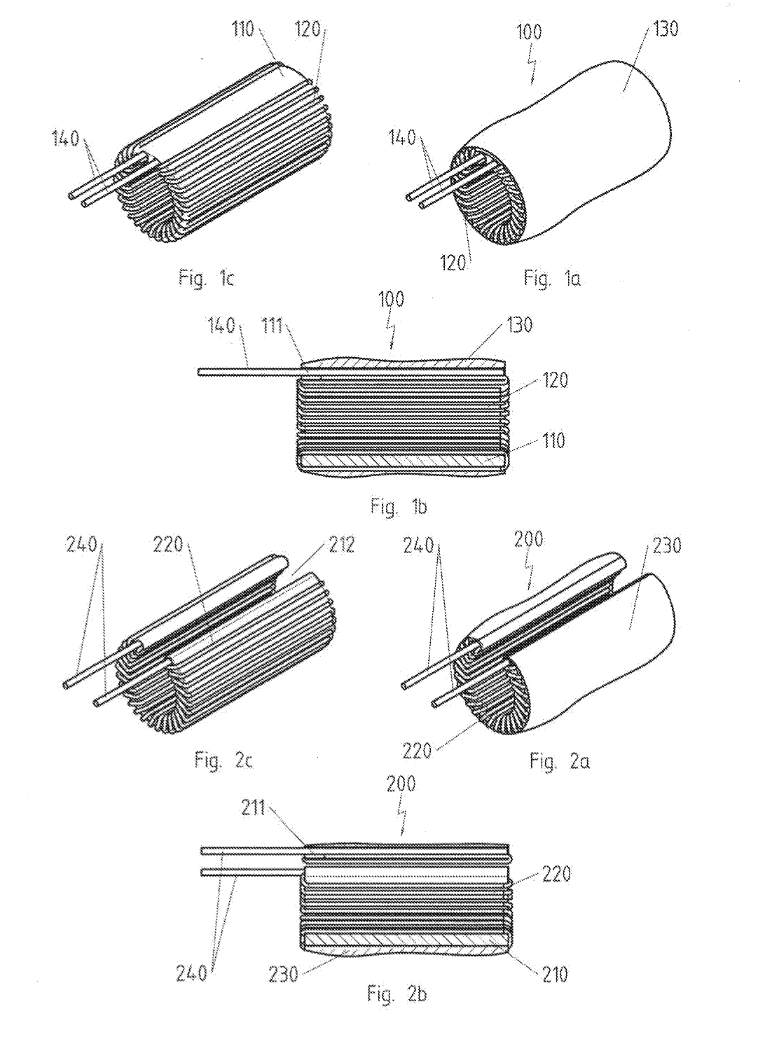

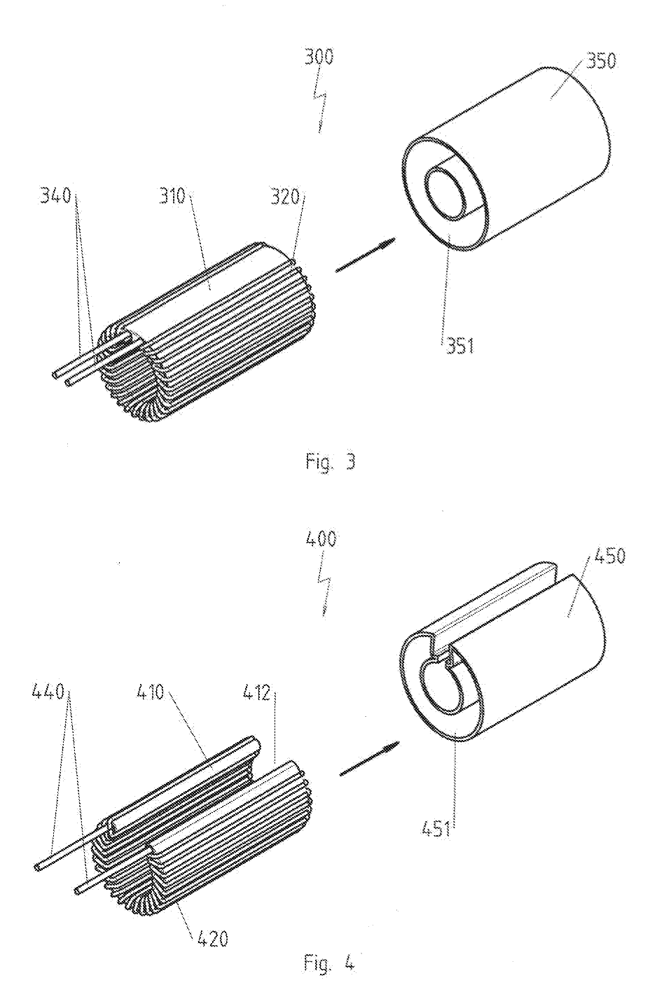

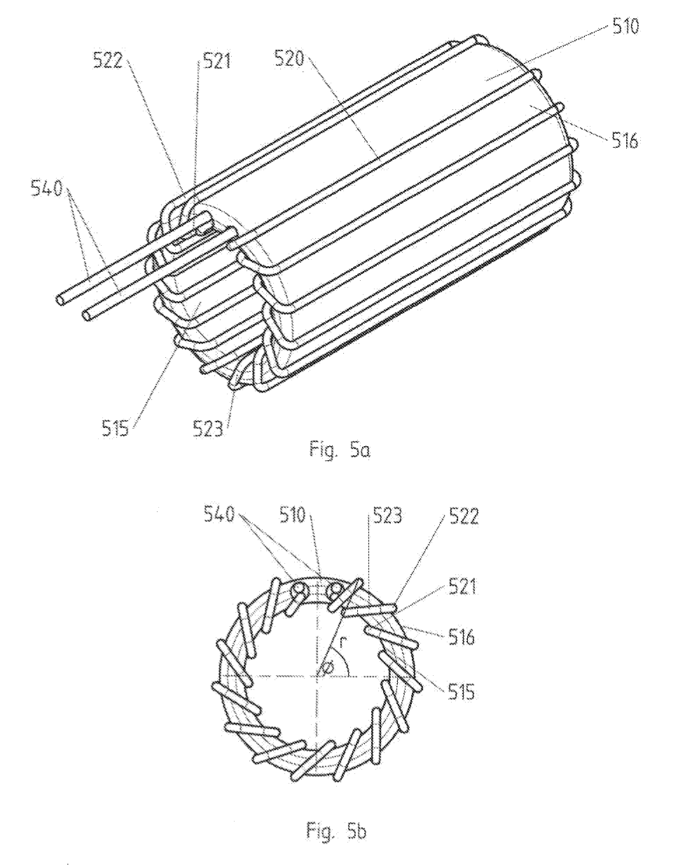

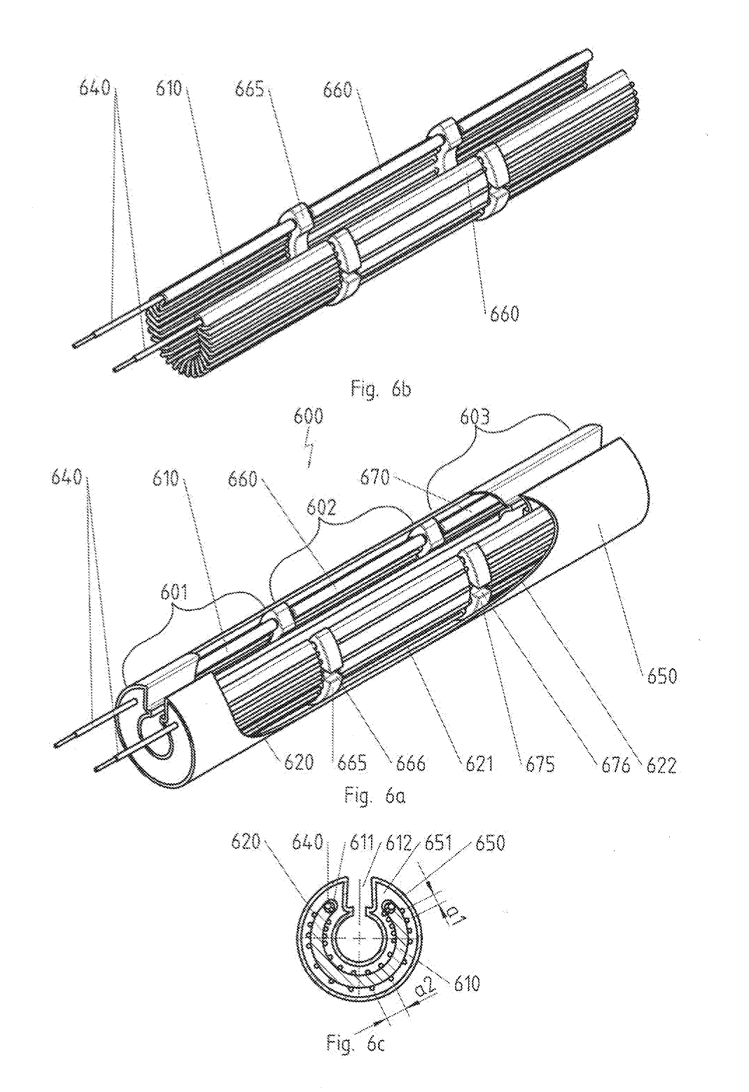

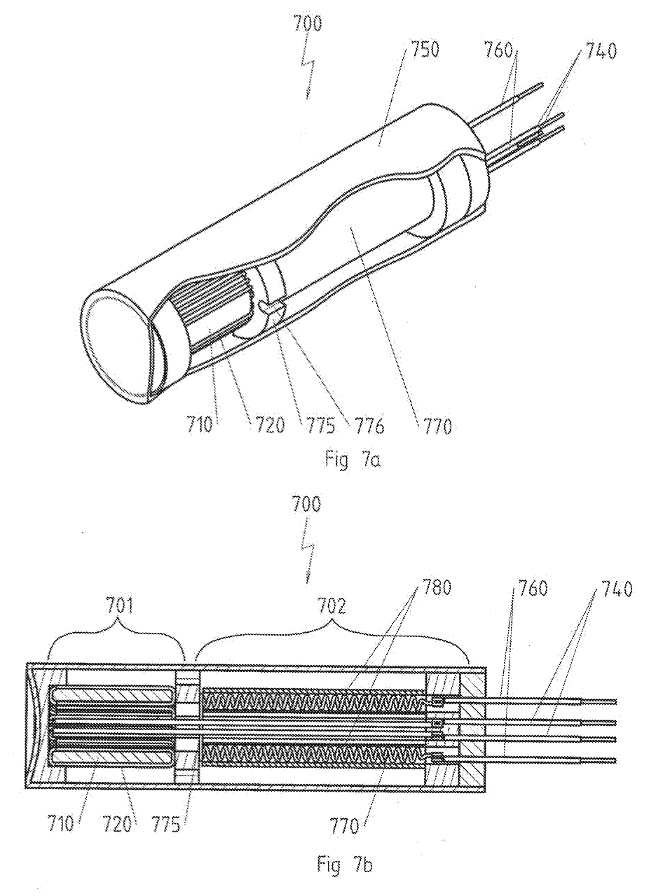

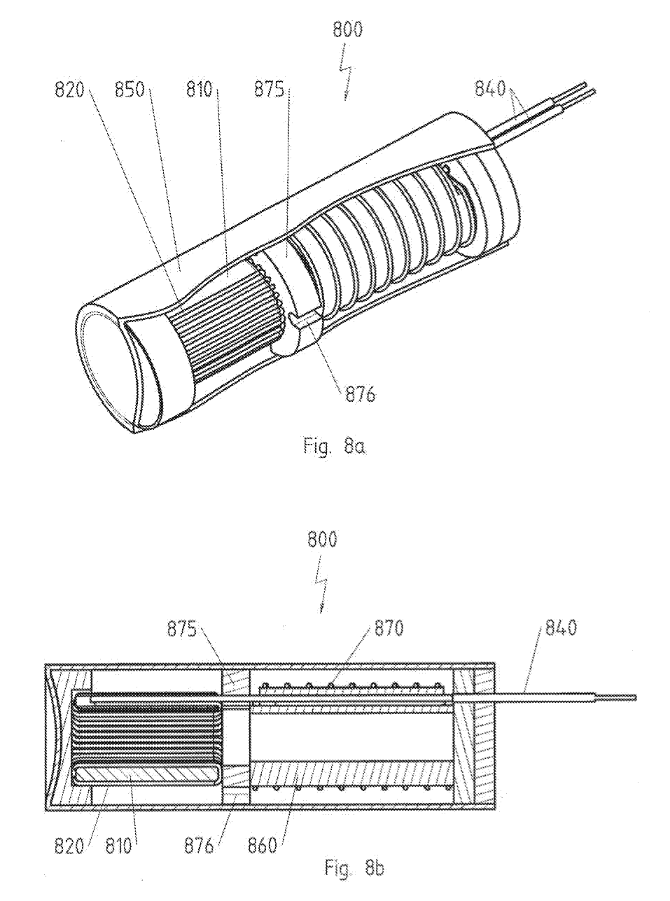

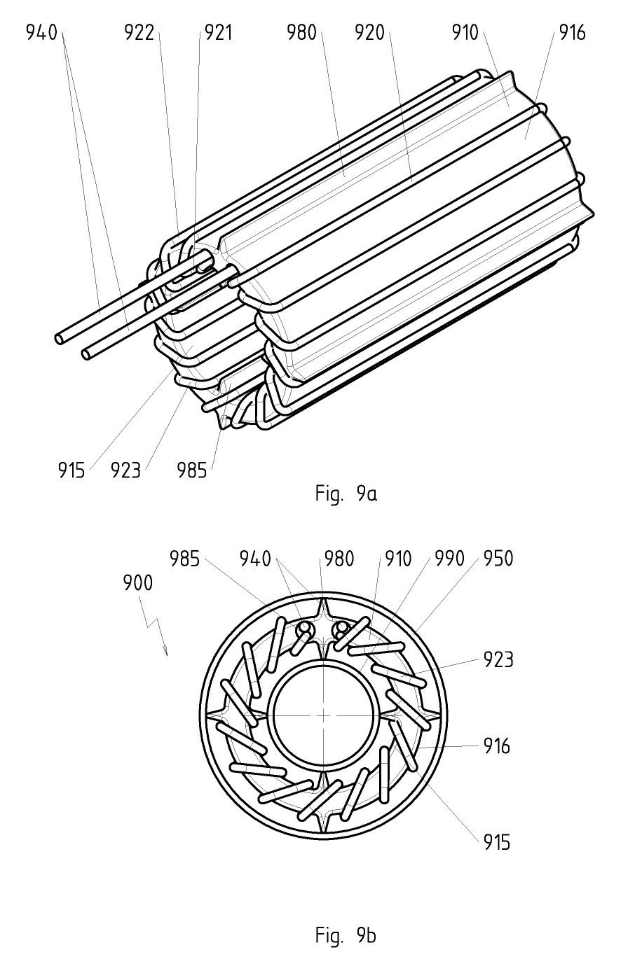

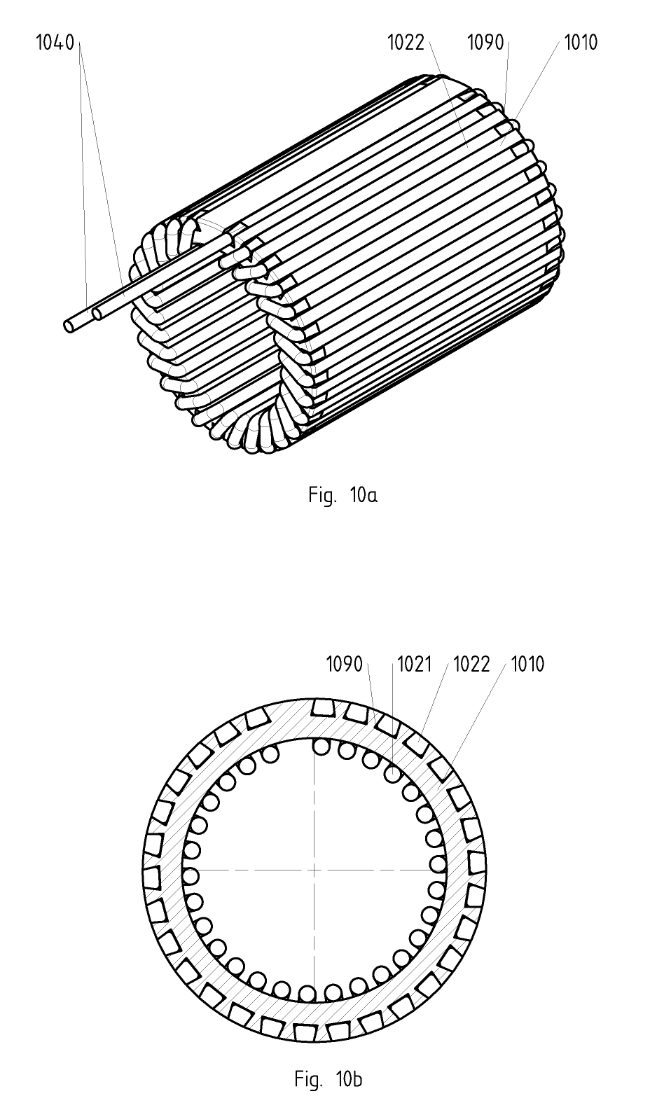

FIG. 2b is a cross sectional view through the electric heater from FIG. 2a along the longitudinal axis thereof;

FIG. 2c is a perspective view of the wound coil body of the electric heater from FIG. 2a;

FIG. 3 is a perspective, partial exploded view of a second electric heater;

FIG. 4 is a perspective, partial exploded view of a variant of the electric heater from FIG. 3;

FIG. 5a is a perspective view of a wound coil body for an electric heater;

FIG. 5b is an end view showing an end face of the wound coil body from FIG. 5a;

FIG. 6a is a perspective view of a partially opened third electric heater;

FIG. 6b is a perspective view showing the coil body of the electric heater from FIG. 6a;

FIG. 6c is a cross sectional view through the electric heater from FIG. 6a;

FIG. 7a is a perspective view of a partially opened, fourth electric heater;

FIG. 7b is a cross sectional view through the electric heater from FIG. 7a;

FIG. 8a is a perspective view of a partially opened, fifth electric heater;

FIG. 8b is a cross sectional view through the electric heater from FIG. 8a;

FIG. 9a is a perspective view showing a variant of the wound coil body according to FIG. 5a;

FIG. 9b is an end view showing the opened end face of an electric heater with a wound coil body shown in FIG. 9a;

FIG. 10a is a perspective view of another variant of a wound coil body, and

FIG. 10b is a cross sectional view in a plane at right angles to the extension direction through the wound coil body from FIG. 10.

### DESCRIPTION OF THE PREFERRED EMBODIMENTS

Referring to the drawings, FIGS. 1a and 1b show an electric heater 100, which comprises a coil body 110 in the form of a tube with a circular cross section, an electric heating element 120 wound thereon in the form of a resistance wire and an electrically insulating cover layer 130, which is applied to the outer side of the wound coil body 110 and which also fixes sections of the electric heating element 120 at the same time, as well as connection wires 140, which are inserted into holes 111 in the coil body 110 and are used to supply the electric heating element 120 with power. FIG. 1c shows a view of the electric heater 100 without the electrically insulating cover layer 130.

As is seen especially clearly in FIGS. 1b and 1c, the electric heating element 120 is wound onto the coil body 110 such that it extends over both sections of the inner side of the tube forming the coil body 110 and sections of the outer side of the tube forming the coil body 110. The electric heating element 120 is wound onto the coil body 110 such that it alternatingly extends over sections of the inner side of the tube forming the coil body 110 and over sections of the outer side of the tube forming the coil body 110. Between a section of the electric heating element 120, which section extends on the inner side of the tube forming the coil body 110, and a section of the electric heating element 120, which section extends on the outer side of the tube forming the coil body 110, the electric heating element 120 extends over an end face of the tube forming the coil body 110.

FIGS. 2a and 2b show a variant of this configuration in the form of an electric heater 200, which comprises a coil body 210 in the form of a tube having a circular cross section, which tube is slotted by the gap 212 extending from one end face to another end face of the coil body 210, and an electric heating element 220 wound thereon in the form of a resistance wire and an electrically insulating cover layer 230, which is applied to the outer side of the wound coil body 210 and which fixes at the same time sections of the electric heating element 220, as well as connection wires 240, which are inserted into holes 211 in the coil body 210 and are used to supply the electric heating element 220 with power. FIG. 2c shows a view of the electric heater 200 without the electrically insulating cover layer 230.

As is seen especially clearly in FIGS. 2b and 2c, the electric heating element 220 is wound onto the coil body 210 such that it extends over both sections of the inner side of the slotted tube forming the coil body 210 and sections of the outer side of the slotted tube forming the coil body 210. The electric heating element 220 is wound here on the coil body 210 such that it alternatingly extends over sections of the inner side of the slotted tube forming the coil body 210 and sections of the outer side of the slotted tube forming the coil body 210. The electric heating element 220 extends over an end face of the slotted tube forming the coil body 210 between a section of the electric heating element 220 that extends on the inner side of the slotted tube forming the coil body 210, and a section of the electric heating element 220 that extends on the outer side of the slotted tube forming the coil body 210.

As can easily be imagined on the basis of FIGS. 2a through 2c, the winding can be carried out much more simply and rapidly on the coil body 210 in the form of a slotted tube than the winding on the coil body 100.

The respective electric heaters 300 and 400 shown in FIGS. 3 and 4 have coil bodies 310 and 410, respectively, on which respective electric heating elements 320 and 420 are wound, which have exactly the same configuration as shown in FIGS. 1c and 2c and were described above. The difference from the electric heaters 100, 200 is that a tubular metal jacket 350 and a slotted tubular metal jacket 450 are present, in the respective interior 351 and 451 of which the wound coil bodies are received. An electrically insulating, preferably having the consistency of powder or granular material, which is not shown here and in the further figures to preserve the clarity of the figures and which may preferably be pressed, is used for the electrical insulation. The preconfigured assembly unit of the coil body 310 and 410 can consequently simply be inserted into the interior 351 of the tubular metal jacket 350 and into the interior 451 of the slotted tubular metal jacket, as it is suggested in FIGS. 3 and 4, respectively, by the arrow, and the remaining interior can then be filled with the electrically insulating powder or granular material, e.g., with a magnesium oxide, and optionally compacted.

The views of a coil body 510, which is not wound particularly tightly with an electric heating element 520 in the form of a resistance wire and is provided with connection wires 540 inserted into holes 511 of the coil body 510, which are shown in FIGS. 5a and 5b, make it possible to illustrate some details of the winding. It is recognized, in particular, on the basis of the radius vector r shown as an example, which extends at a polar angle φ, in the view shown in FIG. 5b that there always is a section 522 of the electric heating element 520 that extends parallel offset in the radial direction on the outer side 516 of the tube for sections 521 of the electric heating element 520 that extend on the inner side 515 of the tube forming the coil body 510 and that the sections 523 of the electric heating element 520 extending over an end face 513 of the tube forming the coil body 510 extend in a direction deviating from the radial direction.

The electric heater 600, which is shown in FIGS. 6a through 6c, is characterized in that it has areas 601, 602, 603 heated at different intensities. This is achieved in that the metal jacket 650, which has the form of a slotted tube, is, electrically insulated from this, e.g., by an optionally pressed MgO powder. An assembly unit, comprising three coil bodies 610, 660, 670, is shown in FIG. 6b. The three coil bodies 610, 660, 670 are separated and insulated from each other by ring segment-shaped plates 665, 675.

The individual coil bodies 610, 660, 670 are configured analogously to the coil body 210 from FIG. 2c and are wound with electric heating elements 620, 621, 622 in the form of heating wires, but they differ in terms of the winding tightness and therefore provide different heat outputs. The assembly unit that is shown in FIG. 6b can be assembled simply by being placed onto the connection wires 640, after which it can be inserted in this preconfigured form into the metal jacket 650 and then be insulated from the metal jacket by filling the remaining volume in the interior of the metal jacket 650 with the electric insulator, MgO powder, and optionally pressed. Reference is made in this connection to the openings 666, 676, which are provided in the ring segment-shaped plates 665, 675 and which facilitate the trickling through of the MgO powder.

Another peculiar feature of the electric heater 600 shown in FIGS. 6a through 6c can be seen upon careful examination of FIG. 6c. As is illustrated by this cross-sectional view, which shows a polar plane of the electric heater 600 in the area of the first coil body 610, the distance a1, a2 between adjacent sections of the electric heating element 620, which are led over sections of the inner side of the slotted tube forming the coil body 610 and are led over sections of the outer side of the slotted tube forming the coil body 610, varies in the circumferential direction, i.e., as a function of the particular polar angle or polar angle range of the tube or slotted tube forming the coil body 610 from one section to the next.

The tightness of the windings of the electric heating element 620 is concretely higher in the areas of the coil body 610 that adjoin the slot or gap 612 in the coil body 610 passing through the coil body 610 from one end face to the other and the distance a1 between respective adjacent sections is smaller on the inner side or outer side of the slotted tube than in the area located opposite the slot or gap 612. The fact that no heat output is provided in the area of the slot or gap 612 proper can be compensated hereby.

A different heat output may, of course, also be provided at different polar angles by corresponding variations of the distance and the winding tightness, e.g., a locally increased heat output may be provided in the area located opposite the slot or gap 612 by providing a high winding tightness at this location.

The electric heater 700 shown in FIGS. 7a and 7b has a coil body 710 wound with an electric heating element 720 with connection wires 740, which coil body 710 is configured and wound analogously to the coil body 110 shown in FIG. 1c with electric heating element 120 and connection wires 140. Similarly to the electric heater 600 discussed in FIGS. 6a through 6c, the electric heater 700 has a plurality of different heated areas, but only two different heated areas 701 and 702 here, which are, however, configured here such that they can be actuated separately, because, in addition to the connection wires 740 for energizing the electric heating element 720, separate connection wires 760 are also provided for energizing heating wire coils 780 received in the interior of a tubular insulator body 770, which is separated from the coil body 710 by a ring-shaped disk 775 with recesses 776. This overall arrangement is arranged in a common tubular metal jacket 750 insulated by MgO powder or granular MgO in the same manner as described above.

The electric heater 800 shown in FIGS. 8a through 8c has a coil body 810 wound with an electric heating element 820 with connection wires 840, which coil body 810 is configured and wound with an electric heating element 120 and connection wires 140 analogously to the coil body 110 shown in FIG. 1c. Similarly to the electric heater 600 discussed in FIGS. 6a through 6c, the electric heater 800 has a plurality of different heated areas, but only two differently heated areas 801 and 802 here, which are energized together by the connection wires 840. The area 802 is heated here by a second coil body 860, which is wound in the circumferential direction rather than axially with an electric heating element 870. The coil bodies 810 and 860 are separated by a circular ring-shaped disk 875 made of an electrically insulating material with recesses 876 here as well and are embedded together in a powdery, electrically insulating material within a tubular metal jacket 850.

The wound coil body 910 shown in FIG. 9a is largely identical to the wound coil body 510 shown in FIGS. 5a and 5b, and reference can therefore extensively be made for its description to the description of these figures, the reference numbers 9a and 9b used in FIG. 9a and being obtained by adding 400 from the corresponding reference numbers of the FIGS. 5a and 5b.

The difference between the coil bodies 510 and 910 is that spacers 980, configured, as an example, as ribs, are arranged on the latter on the outer side of the tube of the coil body 910 and spacers 985 are arranged on the inner side of the tube of the coil body 910. Other spacer geometries are, of course, also conceivable. The effect and function of these spacers 980, 985 is seen in the views shown in FIG. 9b, which shows the wound coil body from FIG. 9a in an electric heater 900: They guarantee accurate positioning of the wound coil body 910 relative to an outer tubular metal jacket 950 and to an inner tubular metal jacket 990 of the electric heater 900.

As is seen on the tubular coil body 1010 shown in FIGS. 10a and 10b, it is also possible to insert individual sections 1022 of the electric heating element into grooves 1090 or depressions of the coil body 1010, which may also have an undercut, as in the example being shown here, and which are arranged on the outer side thereof in this example, but may also be arranged on the inner side or at the end face and also do not need to be present for each winding of the electric heating element, unlike in the example being shown here.

It is preferred in this connection if the sections 1022 of the electric heating element 1020, which are inserted into the grooves, are then pressed in while undergoing plastic deformation, so that the surface of the wound coil body becomes flat. This deformation is seen especially well from a comparison of the sections 1022 of the electric heating element 1020 with the sections 1021 in FIG. 10b.

While specific embodiments of the invention have been shown and described in detail to illustrate the application of the principles of the invention, it will be understood that the invention may be embodied otherwise without departing from such principles.

What is claimed is:

1. An electric heater comprising:
at least one coil body in the form of a tube having any desired cross section, in the form of a partially slotted tube having any desired cross section or in the form of a slotted tube having any desired cross section; and
at least one electric heating element wound onto the coil body such that the at least one electric heating element extends both over sections of an inner side of the tube, partially slotted tube or slotted tube forming the coil body and sections of an outer side of the tube, partially slotted tube or slotted tube forming the coil body.

2. An electric heater in accordance with claim 1, wherein the electric heating element is provided on the coil body such that the electric heating element alternatingly extends over sections of the inner side of the tube, partially slotted tube or slotted tube forming the coil body and over sections of the outer side of the tube, partially slotted tube or slotted tube forming the coil body.

3. An electric heater in accordance with claim 2, wherein the electric heating element extends over an end face of the tube, partially slotted tube or slotted tube forming the coil body between a section, which extends on the inner side of the tube, partially slotted tube or slotted tube forming the coil body and a second section that extends on the outer side of the tube, partially slotted tube or slotted tube forming the coil body.

4. An electric heater in accordance with claim 3, wherein the electric heating element comprises a section that extends:
in a radial direction offset in parallel on the outer side of the tube, partially slotted tube or slotted tube forming the coil body for a section of the electric heating element; or
on the inner side of the tube, partially slotted tube or slotted tube forming the coil body; or
over an end face of the tube, partially slotted tube or slotted tube forming the coil body extends in a direction deviating from the radial direction.

5. An electric heater in accordance with claim 1, further comprising an electrically insulating cover layer wherein the electric heater is fixed in at least some sections by embedding the coil body with the at least one electric heating in an electrically insulating cover layer.

6. An electric heater in accordance with claim 5, wherein the cover layer is an enameling, a lacquer layer, a silicone layer, a resin layer, a synthetic resin layer or a ceramic compound.

7. An electric heater in accordance with claim 1, wherein:
the electric heating element comprises adjacent sections;
a distance between the adjacent sections of the electric heating element led over sections of the inner side of the tube, partially slotted tube or slotted tube forming the coil body or which are led over sections of the outer side of the tube, partially slotted tube or slotted tube forming the coil body varies in a circumferential direction of the tube, partially slotted tube or slotted tube forming the coil body from one section to the next.

8. An electric heater in accordance with claim 1, wherein the tube, partially slotted tube or slotted tube forming the coil body comprises a jacket having at least one hole connecting two end faces of jacket to one another.

9. An electric heater in accordance with claim 1, further comprising:
another coil body disposed adjacent to the at least one coil body to provide adjacent coil bodies; and
a plate or disk formed of an electrically insulating material arranged between adjacent coil bodies.

10. An electric heater in accordance with claim 1, wherein the electric heater has at least two areas heated at different intensities.

11. An electric heater in accordance with claim 10, further comprising another coil body disposed adjacent to the at least one coil body to provide adjacent coil bodies wherein the at least two areas heated at different intensities are arranged on different coil bodies.

12. An electric heater in accordance with claim 10, wherein two areas heated at different intensities are located adjacent to one another in the circumferential direction.

13. An electric heater in accordance with claim 1, wherein a perimeter of a cross section of the at least one coil body has at least one straight section.

14. An electric heater in accordance with claim 13, wherein the perimeter of the cross section of the coil body is a polygon.

15. An electric heater in accordance with claim 1, further comprising:
an outer tubular metal jacket; and
an inner tubular metal jacket wherein the coil body is arranged between the outer tubular metal jacket and the inner tubular metal jacket.

16. An electric heater in accordance with claim 1, further comprising a sensor element or feed lines or both a sensor element and feed lines, wherein the coil body is formed by a partially slotted tube or by a slotted tube and the sensor element or the feed lines or both the sensor element and the feed are arranged in the slot.

17. An electric heater in accordance with claim 1, wherein the coil body comprises spacers on an outer side or on an inner side or on both an outer side and on an inner side.

18. An electric heater in accordance with claim 1, wherein the coil body comprises guides on the end face for sections of the electric heating element.

19. An electric heater in accordance with claim 1, wherein the coil body has recesses or grooves into which sections of the electric heating element are inserted.

20. An electric heater in accordance with claim 19, wherein the grooves or recesses of the coil body have an undercut.

21. An electric heater in accordance with claim 20, wherein the sections of the electric heating element, which are inserted into the grooves or recesses of the coil body, are plastically deformed.
